(19) United States
(12) Patent Application Publication
(10) Pub. No.: US 2016/0219574 A1
(43) Pub. Date: Jul. 28, 2016

(54) Method and Apparatus for Device to Device Communication

(71) Applicant: NOKIA TECHNOLOGIES OY, Espoo (FI)

(72) Inventors: Cassio Ribeiro, Espoo (FI); Lars Lindh, Helsingfors (FI); Klaus Hugl, Wien (AT); Juha Korhonen, Espoo (FI); Zexian Li, Espoo (FI)

(21) Appl. No.: 14/909,200

(22) PCT Filed: Aug. 8, 2013
(86) PCT No.: PCT/IB2013/056500

§ 371 Date: Feb. 1, 2016

(51) Int. Cl. H04W 72/04; H04W 76/02; H04W 48/02; H04W 8/00

(52) U.S. Cl. CPC H04W 72/048; H04W 8/005; H04W 76/023; H04W 48/02; H04W 72/042

(57) ABSTRACT

Systems and techniques for managing the use of discovery resources in device to device communication-capable devices. A message is configured for transmission to one or more user devices by a base station to indicate permission or denial of discovery resources, and based on the message, one or more of the user devices receiving the message uses, or is inhibited from using, the resource. Indication of permission or denial may, in various embodiments designate all discovery resources in general, specific resources assigned to groups and allocated to a specific user device, or groups of resources, with permission or denial relating to all members of a group.

### TECHNICAL FIELD

The present invention relates generally to wireless communication. More particularly, the invention relates to proximity service device to device communication.

### BACKGROUND

Device to device communication is gaining more and more interest among wireless communication users and operators, and one approach that has gained particular interest is the use of proximity based services (ProSe). Radio resource control (RRC) in The 3rd Generation Partnership Project (3GPP) long term evolution (LTE) systems provides for an RRC_CONNECTED state and an RRC_IDLE state, but devices that are able to engage in device to device communication may have a need to discover other devices or to be discovered by other devices whether they are in a connected state or not. Being able to transmit a discovery beacon without entering an RRC_CONNECTED state improves and simplifies discovery operations of devices.

### SUMMARY

In one embodiment of the invention, an apparatus comprises at least one processor and memory storing computer program code. The memory storing the computer program code is configured to, with the at least one processor, cause the apparatus to at least, based on at least one of the reception and content of a message indicating permission for a user device configured for device to device operation to use a discovery resource, allow or inhibit use of the resource by the user device at a subsequent opportunity of use of the resource.

In another embodiment of the invention, an apparatus comprises at least one processor and memory storing computer program code. The memory storing the computer program code is configured to, with the at least one processor, cause the apparatus to at least configure a message indicating grant or denial of permission to one or more user devices configured for device to device operation to use discovery resources at a subsequent opportunity for use of the resource; and cause transmission of the message by a base station serving the user devices for device to device operation.

In another embodiment of the invention, a method comprises, based on at least one of the reception and content of a message indicating permission for a user device configured for device to device operation to use a discovery resource, allowing or inhibiting use of the resource by the user device at a subsequent opportunity of use of the resource.

In another embodiment of the invention, a method comprises configuring a message indicating grant or denial of permission to one or more user devices configured for device to device operation to use discovery resources at a subsequent opportunity for use of the resource and causing transmission of the message by a base station serving the user devices for device to device operation.

In another embodiment of the invention, the message indicates permission for use of all discovery resources available for use by the user device at a subsequent opportunity for use of the resources.

In another embodiment of the invention, the message points to the configured specific resource or configured resource group and indicates a grant or denial of the at least the specific resource or the resource group allocated to the user device.

In another embodiment of the invention, the message is part of a downlink control information.

In another embodiment of the invention, the message is carried on a physical downlink control channel.

In another embodiment of the invention, the downlink control information is a compact downlink control information format scrambled with a device to device radio network temporary identifier configured for user devices within coverage of a base station.

In another embodiment of the invention, the apparatus is further caused to receive as part of the device-to-device operation configuration information identifying one or more specific resources or a resource groups as well as the device to device radio network temporary identifier configured for the user device.

In another embodiment of the invention, the message indicates explicit permission or denial of use of resources for one or more specified user devices.

In another embodiment of the invention, the message specifies at least one group of user devices and indicates explicit permission or denial for the group, and wherein specifying of a user device comprises identifying the user device as a member of the group.

In another embodiment of the invention, the message comprises a first element defining a group of indexes to user device groups and a second element comprising an index to user devices within the group defined by the first element, such that the two elements together specify a user device.

In another embodiment of the invention, the first element comprises a radio network temporary identifier.

In another embodiment of the invention, failing to receive the message for a predetermined number of consecutive times indicates a deactivation of use of configured discovery resources.

In another embodiment of the invention, receiving a message indicating permission to use the configured discovery resources comprises receiving a message indicating explicit denial of permission.

In another embodiment of the invention, receiving a message indicating explicit denial to use the configured discovery resources comprises an indication as to whether the denial applies only to a limited number of opportunities or indicates a deactivation of use of configured discovery resources.

In another embodiment of the invention, if receiving a message indicating explicit denial to use the configured discovery resources exceeds a predetermined number of consecutive denials, the denial indicates a deactivation of use of the configured discovery resources.

In another embodiment of the invention, a computer readable medium stores a program of instructions. Execution of the program of instructions by a processor configures an apparatus to at least, based on at least one of the reception and content of a message indicating permission for a user device configured for device to device operation to use a discovery resource, allow or inhibit use of the resource by the user device at a subsequent opportunity of use of the resource. the message indicates grant or denial of use of all discovery resources determined by the base station at a subsequent opportunity for use of the resource.

In another embodiment of the invention, the apparatus is further caused to configure for transmission to the user devices by the base station a message including configuration information allocating specific resources to user devices and defining resource group to which the resource belong and providing an index assigning specific resources to specific devices, wherein the message indicating a grant or denial points to a resource group and indicates a grant or denial of a resource within the resource group and allocated to the user device.

In another embodiment of the invention, the apparatus is further caused to configure for transmission to the user devices by the base station a message indicating a grant or denial of one or more resource groups, wherein a grant or denial of a resource group indicates grant or denial of all resources comprising the resource group.

In another embodiment of the invention, a computer readable medium stores a program of instructions. Execution of the program of instructions by a processor configures an apparatus to at least configure a message indicating grant or denial of permission to one or more user devices configured for device to device operation to use discovery resources at a subsequent opportunity for use of the resource; and cause transmission of the message by a base station serving the user devices for device to device operation.

In another embodiment of the invention, an apparatus comprises means for, based on at least one of the reception and content of a message indicating permission for a user device configured for device to device operation to use a discovery resource, allowing or inhibiting use of the resource by the user device at a subsequent opportunity of use of the resource.

In another embodiment of the invention, the message indicates permission for use of all discovery resources available for use by the user device at a subsequent opportunity for use of the resources.

In another embodiment of the invention, the message points to the configured specific resource or configured resource group and indicates a grant or denial of the at least the specific resource or the resource group allocated to the user device.

In another embodiment of the invention, the message is part of a downlink control information.

In another embodiment of the invention, the message is carried on a physical downlink control channel.

In another embodiment of the invention, the downlink control information is a compact downlink control information format scrambled with a device to device radio network temporary identifier configured for user devices within coverage of a base station.

In another embodiment of the invention, the apparatus further includes means for receiving as part of the device-to-device operation configuration information identifying one or more specific resources or a resource groups as well as the device to device radio network temporary identifier configured for the user device.

In another embodiment of the invention, the message indicates explicit permission or denial of use of resources for one or more specified user devices.

In another embodiment of the invention, the message specifies at least one group of user devices and indicates explicit permission or denial for the group, and wherein specifying of a user device comprises identifying the user device as a member of the group.

In another embodiment of the invention, the message comprises a first element defining a group of user device groups and a second element comprising an index to user devices within the group defined by the first element, such that the two elements together specify a user device.

In another embodiment of the invention, the first element comprises a radio network temporary identifier.

In another embodiment of the invention, failing to receive the message for a predetermined number of consecutive times indicates a deactivation of use of configured discovery resources.

In another embodiment of the invention, receiving a message indicating permission to use the configured discovery resources comprises receiving a message indicating explicit denial of permission.

In another embodiment of the invention, receiving a message indicating explicit denial to use the configured discovery resources comprises an indication as to whether the denial applies only to a limited number of opportunities or indicates a deactivation of use of configured discovery resources.

In another embodiment of the invention, if receiving a message indicating explicit denial to use the configured discovery resources exceeds a predetermined number of consecutive denials, the denial indicates a deactivation of use of the configured discovery resources.

In another embodiment of the invention, an apparatus comprises means for configuring a message indicating grant or denial of permission to one or more user devices configured for device to device operation to use discovery resources at a subsequent opportunity for use of the resource and means for causing transmission of the message by a base station serving the user devices for device to device operation.

In another embodiment of the invention, the message indicates grant or denial of use of all discovery resources determined by the base station at a subsequent opportunity for use of the resource.

In another embodiment of the invention, the apparatus further comprises means for configuring for transmission to the user devices by the base station a message including configuration information allocating specific resources to user devices and defining resource group to which the resource belong and providing an index assigning specific resources to specific devices, wherein the message indicating a grant or denial points to a resource group and indicates a grant or denial of a resource within the resource group and allocated to the user device.

In another embodiment of the invention, the apparatus further comprises means for configuring for transmission to the user devices by the base station a message indicating a grant or denial of one or more resource groups, wherein a grant or denial of a resource group indicates grant or denial of all resources comprising the resource group.

### BRIEF DESCRIPTION OF THE DRAWINGS

FIG. 1 illustrates a network operating according to an embodiment of the present invention;

FIGS. 2-5 illustrate processes according to an embodiment of the present invention;

FIG. 6 illustrates a message and resource sequence according to an embodiment of the present invention; and

FIG. 7 illustrates elements for carrying out one or more embodiments of the present invention.

### DETAILED DESCRIPTION

Embodiments of the invention recognize that semi-static allocation for discovery beacon transmission reduces signaling for indicating each beacon resource instance, and also offers the possibility of reducing UE power consumption. For UEs in an RRC_{—} CONNECTED state with a long discontinuous reception (DRX) cycle, semi-static allocation can also result in lower power consumption by allowing longer DRX cycles.

Embodiments of the invention recognize, however, that semi-static discovery resource allocation extending over long periods unfavorably limits eNB scheduling flexibility. Therefore, one or more embodiments of the invention provide fast and efficient mechanisms to specify when resources are and are not available for discovery.

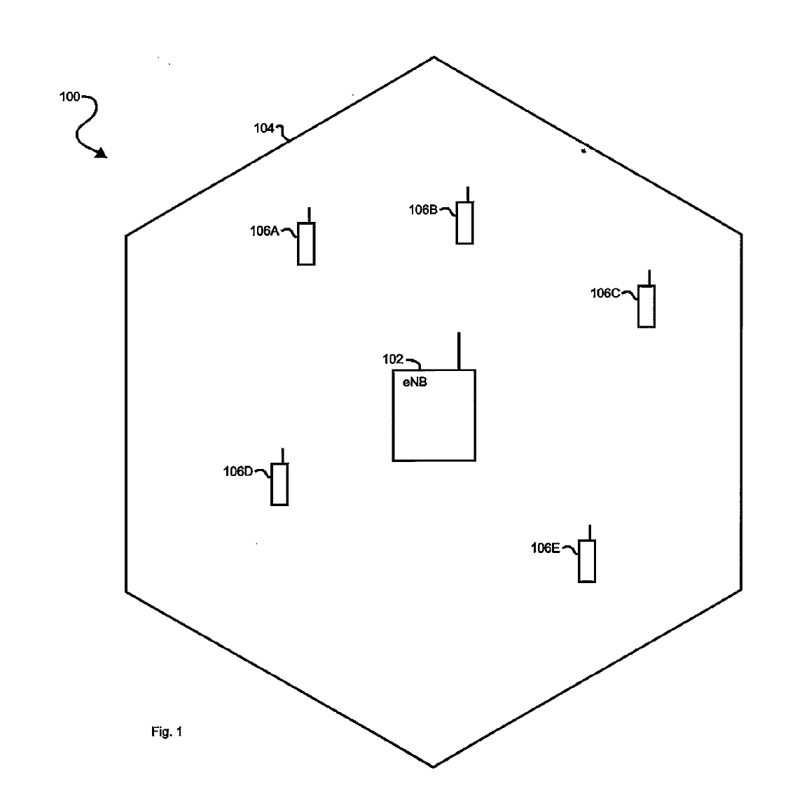

FIG. 1 illustrates a cellular wireless network 100, comprising a base station suitably implemented as an eNBs 102, defining a cell 104. The eNB 102 serves UEs 106A-106E, which are device to device (D2D) capable UEs and in the present exemplary case one or more of the UEs 106A-106E are configured to engage in discovery operations in order to recognize the presence of another D2D device—for example, transmitting a discovery beacon or signal, recognizing a discovery beacon or signal, or both. Embodiments of the invention provide mechanisms for fast and flexible reconfiguration of D2D discovery resources that may be semi-statically configured for a UE or group of UEs, in networks such as the network 100 of FIG. 1.

For UEs in an RRC_{—} CONNECTED state with DRX on, it is possible for the network to control and dynamically configure or reconfigure the D2D discovery resource, but such configuration or reconfiguration involves signaling overhead. For UEs in RRC_IDLE or DRX-off states, the eNB cannot change the semi-static beacon configuration until the UE is configured to listen to downlink signals again. The problem, then, is how to inform UEs in an RRC_IDLE state about a re-configuration or temporary suspension of the validity of the configuration.

One approach is to deliver the full re-configuration information, such as by a paging message, by adding relevant information. In this case, the paging cycle is the minimum time interval to change a beacon transmission resource or activate/de-activate beacon transmission. This solution still implies significant restriction on eNB scheduling flexibility, especially if the paging cycle is set to be long (a paging cycle can be configured to last for between 32 and 256 radio frames).

Another possibility is to deliver the information through a system information block (SIB). More specifically, when the network changes (some of the) system information, it first notifies the UEs about this upcoming change. This may be done, for example, throughout a modification period. In the next modification period, the network transmits the updated system information. Upon receiving a change notification, the UE acquires the new system information immediately from the start of the next modification period. The UE applies the previously acquired system information until the UE acquires the new system information.

A paging message may be used to inform UEs in an RRC_IDLE state and UEs in an RRC_CONNECTED state about a system information change. If the UE receives a paging message including an element indicating a change to system information, the UE recognizes that the system information will change at the next modification period boundary. Therefore the use of a paging message to indicate a change to system information presents the same difficulty as does as using paging message to indicate the re-configuration, that is, longer latency.

Embodiments of the present invention provide for fast and flexible suspension of D2D discovery resources without introducing unnecessary signaling and unnecessary reconfigurations of system information, by defining grants or denials of permission to use discovery resources. The grants or denials appear in a resource, such as a specified portion of the physical downlink control channel (PDCCH) or the enhanced physical downlink control channel (EPDCCH) that may be read by UEs such as the UEs 106A-106E even when they are in an RRC_IDLE state. An indication as to grant or denial precedes a discovery opportunity and in one or more embodiments of the invention.

In one or more embodiments of the invention, network coverage configured is such that each UE that participates in the D2D discovery process through being configured to be actively discoverable, or to be able to discover other UEs, or both, is informed in a semi-static way about the exact resources (such as subframes and frequency resources) to be used to transmit the discovery beacon or signal, or receive a discovery beacon or signal. Different groups of UEs may potentially transmit their beacons in different subframes and/or frequency resources. An eNB may use RRC signaling as one mechanism for sending configuration information to its corresponding UEs. Those UEs that are only listening to discovery beacons but do not transmit their own beacons may still be informed of general beacon configuration—for example subframes where beacons are transmitted, and general information about beacon formats in use in the environment. The eNB may use RRC signaling as one mean to send this configuration information, or alternatively the configuration can be included in system information or other broadcast information.

In one or more embodiments of the invention, D2D discovery resources are semi-statically configured for a UE or a group of UEs. Such semi-static configuration might include the configuration of (a) resources to be used by a UE for its own discovery signal/beacon transmission as well as (b) resources available for discovery overall (for example, to allow the UE to monitor or look for discovery signals of other UEs). Before the UE is allowed to transmit its own discovery signal or beacon on a pre-configured resource, it needs to receive a confirmation that the resource is actually available. The confirmation may come through, for example, a Physical Downlink Control Channel (PDCCH) or Enhanced Physical Downlink Control Channel (EPDCCH) monitored by the UE (including, potentially, early wake up shortly before the pre-configured beacon transmission opportunity). The indication message need not necessarily be UE-specific, but instead may be defined such that it is valid for all UEs or specific resources or for a group of UEs. If the network does not allow transmission of the beacon, the UE may assume that the denial applies only to a single beacon transmission opportunity and UE may transmit its beacon on the next opportunity upon receiving a positive indication for that opportunity. In one or more other embodiments, alternative UE behaviors may be defined—for example, that a denial applies to all future pre-configured beacon opportunities of a UE, and the UE has to wait for re-configuration of the resources before it can continue beacon transmissions. Such an approach represents an invalidation of the current discovery beacon transmission configuration.

In one or more embodiments of the invention, a compact DCI message comprising as an information element only a “1” or “0”—indicating a D2D grant or denial—may be transmitted in a common search space. This message may be used to confirm the resources that may be used for transmission in a subsequent subframe. A value of “1” indicates to all D2D UEs that a beacon transmission can be used and a value of “0” indicates that the beacon transmission opportunity appearing in a specified subsequent subframe cannot be used. The “0” value indicates that the UE is not supposed to transmit its discovery beacon in that subframe, and also does not need to scan for discovering beacons. The compact DCI format might, for example, be structured as a combination of repetition coding combined with scrambling of some D2D_RNTI. In another approach, CRC might be attached using the D2D_RNTI. The D2D_RNTI as such may be configured for the UEs within the coverage of a base station. The compact DCI format may be scrambled with D2D_RNTI.

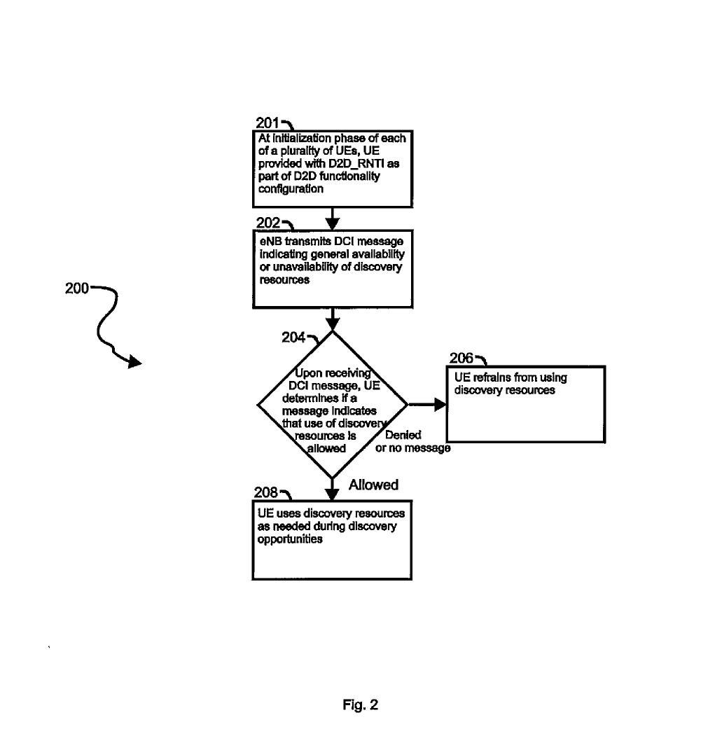

Thus, FIG. 2 illustrates a process according to an embodiment of the present invention. At block 201, at an initialization phase of each of a plurality of UEs configured with D2D communication capability, the UE is provided with a D2D_{—} RNTI as part of the overall D2D functionality configuration. At block 202, an eNB transmits a DCI message as described above, indicating general availability or unavailability of D2D discovery resources in a specified subsequent subframe. At block 204, upon receiving the DCI message, a UE determines if the DCI message indicates that use of discovery resources is allowed or denied. If use of resources is not allowed or no DCI message is found, the process proceeds to block 206 and the UE refrains from using discovery resources. If use of resources is allowed, the process proceeds to block 208 and the UE uses discovery resources as needed during discovery opportunities.

In another embodiment of the invention, a compact DCI message, which is also transmitted in the common search space, is used to dynamically confirm the resources that can be used for transmission of the beacon in the next (or some subsequent) subframe. Here the format may be called “D2D beacon resource confirmation” (D2D BRES) and the following information is transmitted:
BRES number 1, BRES number 2, . . . , BRES number M,
   where M≦L_{format0}, and where L_{format0} is equal to the payload size of format 0 before CRC attachment, including any padding bits appended to format 0. The BRES numbers are one bit of information each. The CRC to be attached is scrambled with the BRES-RNTI_n, where n defines a group of beacon resources. The parameter BRES-Index provided by higher layers determines the index to the beacon resource group defined by the RNTI of the format.

Each UE participating in the D2D process will be informed in the initialization phase from higher layers about the group number BRES_RNTI_n of its configured resource as well of the BRES-Index in the group.

The Format “D2D_BRES” is transmitted one subframe (or a few subframes) before the beacon is scheduled to be transmitted and a value of “1” of the corresponding BRES number is to be interpreted as a confirmation that use, such as transmission, is allowed in that group of beacon resources. If the value is “0” or “D2D_BRES” is not received in that subframe, the beacons mapped to those groups will not be transmitted in that resource and subframe. The subframe-by-subframe indication described above is not the only alternative but the BRES-Index may also point to a resource group within a number of subframes. For instance, the BRES-Index could indicate a resource group in a particular subframe of a radio-frame and the “D2D_BRES” would be transmitted only once in a radio-frame.

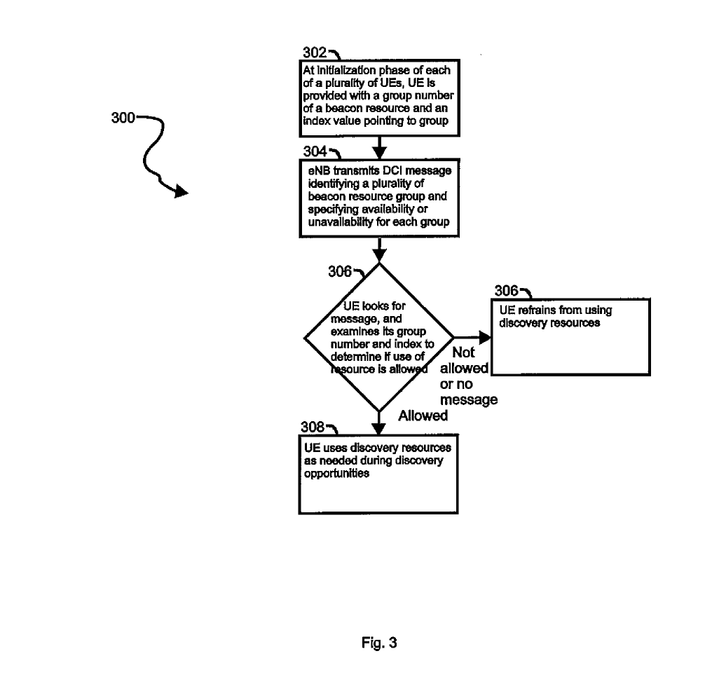

FIG. 3, then, presents a process 300 according to another embodiment of the present invention. At block 302, at an initialization phase of each of a plurality of UEs configured with D2D communication capability, the UE is provided with a group number BRES_RNTI_n of a beacon resource with which the UE is configured, as well as a BRES-Index value pointing to the group. At block 304, an eNB transmits a compact DCI message identifying a plurality of beacon resource groups and specifying availability or unavailability with respect to each group. The DCI message may be a D2D_BRES message, transmitted one or a few subframes before the subframe scheduled for transmission of the beacon. The D2D_BRES message comprises a value of “0” or “1” for each BRES number, indicating denial, or allowance, respectively, of transmission using a specified subframe and a resource within that subframe corresponding to the group associated with the BRES number.

At step 306, one or more UEs looks for the D2D_BRES message in its expected subframe and, if the message is found, examines the message for the group number of the group with which it is associated, and examines the group number and the index to determine if use of the beacon resource is allowed for the specific resource allocated to the UE within the UE's group. For each UE, if yes, the process proceeds to step 308 and the UE uses the beacon resource as needed at the next beacon transmission opportunity. If no, or if the BRES message is not received, the resource associated with the group is not used.

Another embodiment of the invention combines features of the approaches described above. In this embodiment, a compact DCI message, transmitted in the common search space, is used to dynamically confirm the UEs that are allowed to transmit beacons in the next (or some subsequent) configured beacon opportunity. The difference between this approach and those described above is that the bits of the format are used to confirm specific UEs or UE groups, configured by higher layers, instead of the resources configured for those UEs. Here the format is called Format D2D UG (D2D UE group confirmation) and the following information is transmitted:
UG number 1, UG number 2, UG number M,
   where M≦L_{format0}, and where L_{format0} is equal to the payload size of format 0 before CRC attachment, including any padding bits appended to format 0. The UG numbers are one bit of information each. The CRC to be attached is scrambled with the UG-RNTI_p, where p defines a group of UE groups. The parameter UG-Index provided by higher layers determines the index to the UE group defined by the RNTI of the format.

Each UE participating in the D2D process will be informed in the initialization phase from higher layers about its UG_RNTI_p as well as the UG-Index in the format.

The Format “D2D_BRES” is transmitted one subframe (or a few subframes) before the beacon configured for that UE or UE group is scheduled to be transmitted, and a value of “1” of the corresponding UG number is to be interpreted as a confirmation that use, such as transmission, is allowed in that UE or UE group. If the value is “0” or “D2D_UG” is not received in that subframe, the UEs mapped to those groups will not be allowed to transmit in their configured resources.

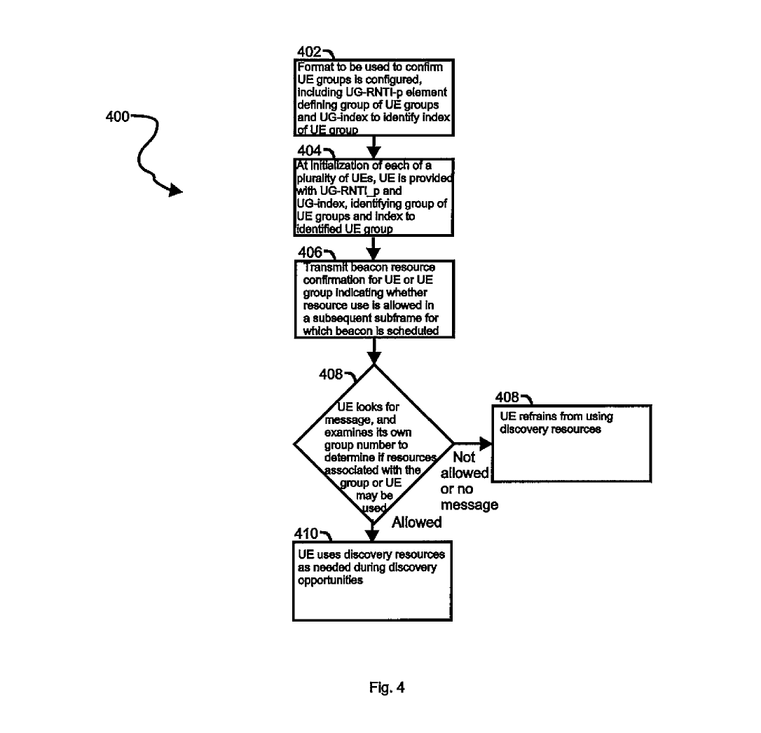

FIG. 4, therefore, presents a process 400 according to another embodiment of the present invention. At block 402, a compact DCI message is defined, for confirming specific UEs or UE groups configured by higher layers, with UG-Index comprising an index to a UE group defined by eNB, and UG-RNTI_p defining a group of UG-indexes. It will be recognized that a group of UEs may have only a single member. At block 404, at initialization of each of a plurality of UEs, UE is provided with UG-RNTI-p and UG-Index. At block 406, a D2D_UG message is transmitted by an eNB, with a designation for each group that the group is enabled or disabled. An indication for the group applies to each resource associated with the group.

At block 408, each of a plurality of UEs looks for the D2D_UG message and, if the message is found, examines the message to determine the status of its own associated group. If no message is found or the group or UE is disabled, the process proceeds to block 408 and the UE is inhibited from using the resource. If the group is enabled, the process proceeds to block 408 and the UE uses its configured resource.

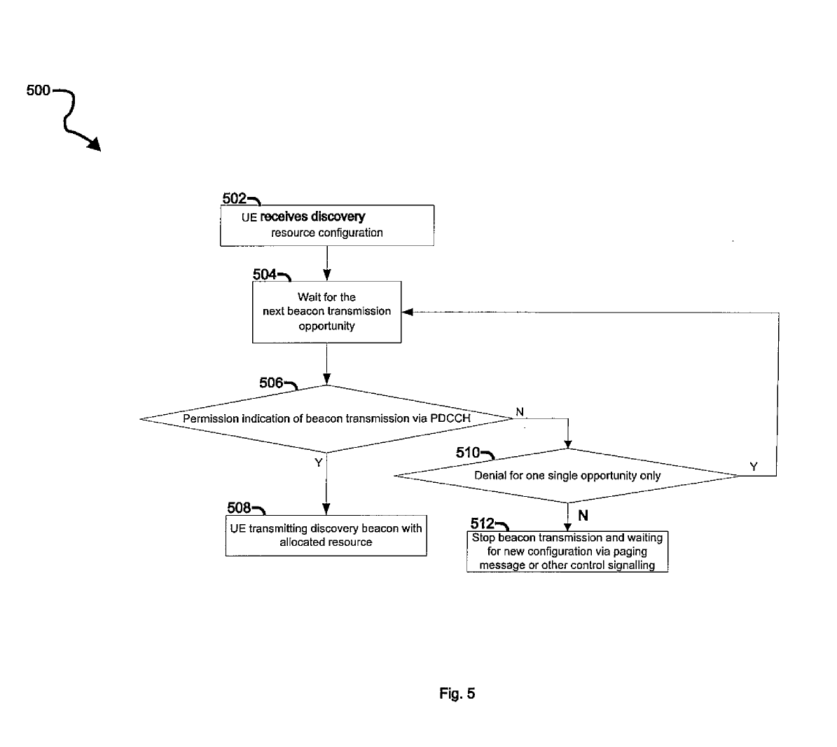

As noted above, denial may indicate denial for a single opportunity, or a general deactivation of discovery resources. FIG. 5 therefore illustrates a process 500 of configuring beacon resources and determining if permission for their use is granted or denied. At block 502, a UE receives a discovery resource configuration. At block 504, the UE waits for the next beacon transmission opportunity. At block 506, a determination is made as to whether permission has been given for beacon transmission (such as through mechanisms such as those described above). If yes, the UE transmits a discovery beacon using its allocated resource. If no, a further determination is made at block 510 as to whether the denial is for only a single opportunity or represents a deactivation. The further determination can be based on an indication transmitted along with the denial. Another possibility is that the type of denial is indicated in the D2D configuration itself or is simply defined in the specifications. Yet another possibility is a rule that a certain number of consecutive denials triggers deactivation. If the denial is for a single opportunity, the process returns to block 504 and the UE waits for the next transmission opportunity. If the denial represents a deactivation, the process proceeds to block 512 and the UE stops all beacon transmission and waits for a new configuration through a paging message or other control signaling.

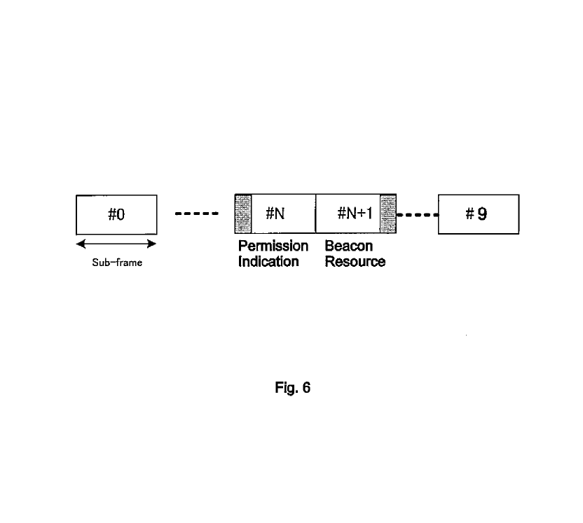

The message or other information indicating whether a UE is permitted to use a discovery resource may be sequenced in any way desired, so long as the permission indication comes before the resource and so long as the UE is configured to expect the information in the sequence in which it appears. For example, FIG. 6 illustrates a sequence of subframes 0-10, with a permission indicating appearing in subframe #N and a discovery resource appearing in subframe #N+1. However, it will be understood that the permission indication may appear in any earlier subframe, so long as the position of the permission indication and the timing between the grant and the use of resources is known by the UE for example by configuration and there is sufficient processing time for the UE. In systems using time division duplex, the timing between the grant and use of the resources may suitably be configured so as to take into account the TDD frame structure in use as well.

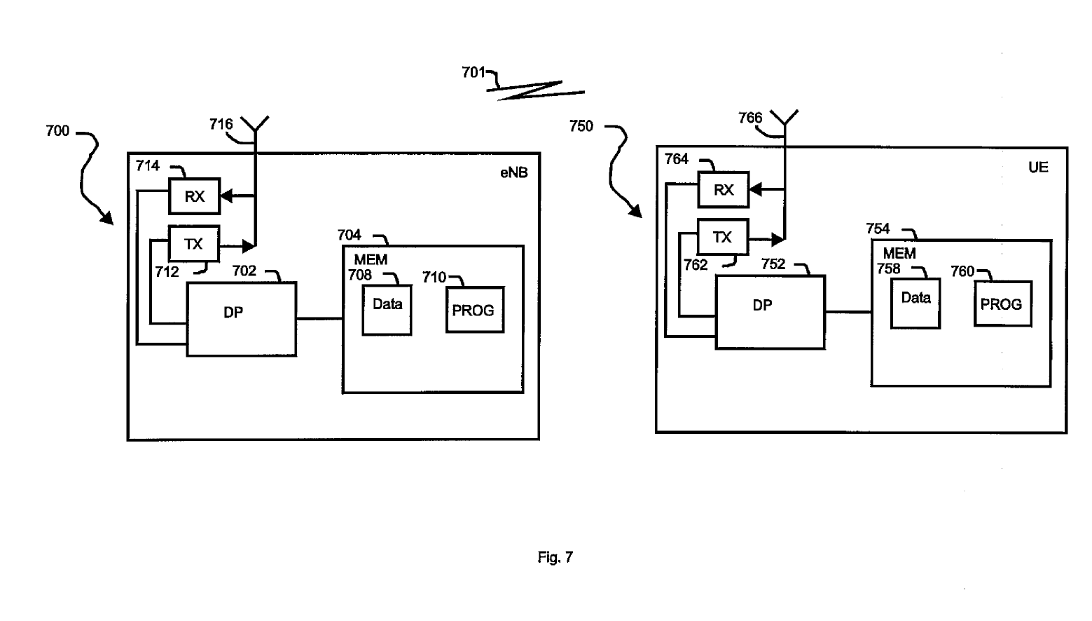

Reference is now made to FIG. 7 for illustrating a simplified block diagram of various electronic devices and apparatus that are suitable for use in practicing the exemplary embodiments of this invention. In FIG. 7 an eNB, such as the eNB 700, is adapted for communication over a wireless link 701 with an apparatus, which may be, for example, be a mobile device/terminal such as a UE 750. The eNB 700 may be any access node (including frequency selective repeaters) of any wireless network such as LTE, L FE-A, GSM, GERAN, WCDMA, and the like.

The eNB 700 includes processing means such as at least one data processor (DP) 702, storing means such as at least one computer-readable memory (MEM) 704 storing data 708, at least one computer program (PROG) 710 or other set of executable instructions, communicating means such as a transmitter TX 712 and a receiver RX 714 for bidirectional wireless communications with the UE 750 (or UEs) via one or more antennas 716.

The UE 750 also includes processing means such as at least one data processor (DP) 752, storing means such as at least one computer-readable memory (MEM) 754 storing data 758 and at least one computer program (PROG) 760 or other set of executable instructions. The UE 750 may also include communicating means such as a transmitter TX 762 and a receiver RX 764 for bidirectional wireless communications with the eNB 700 via one or more antennas 766.

At least one of the PROGs 712 in the eNB 700 is assumed to include a set of program instructions that, when executed by the associated DP 702, enable the device to operate in accordance with the exemplary embodiments of this invention, as detailed above. The UE 750 also stores software 760 in its MEM 754 to implement certain aspects of these teachings. In these regards the exemplary embodiments of this invention may be implemented at least in part by computer software stored on the MEM 704 and 754, which is executable by the DP 702 of the eNB 700 and/or by the DP 752 of the UE 750, or by hardware, or by a combination of tangibly stored software and hardware (and tangibly stored firmware). Electronic devices implementing these aspects of the invention need not be the entire devices as depicted at FIG. 7 or may be one or more components of same such as the above described tangibly stored software, hardware, firmware and DP, or a system on a chip SOC or an application specific integrated circuit ASIC.

In general, the various embodiments of the UE 750 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEMs 704 and 754 include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 702 and 752 include but are not limited to general purpose computers, special purpose computers, microprocessors, digital signal processors (DSPs) and multi-core processors.

While various exemplary embodiments have been described above it should be appreciated that the practice of the invention is not limited to the exemplary embodiments shown and discussed here. Various modifications and adaptations to the foregoing exemplary embodiments of this invention may become apparent to those skilled in the relevant arts in view of the foregoing description. It will be further recognized that various blocks discussed above may be performed as steps, but the order in which they are presented is not limiting and they may be performed in any appropriate order with or without additional intervening blocks or steps.

Further, some of the various features of the above non-limiting embodiments may be used to advantage without the corresponding use of other described features.

The foregoing description should therefore be considered as merely illustrative of the principles, teachings and exemplary embodiments of this invention, and not in limitation thereof.

1-42. (canceled)

43. An apparatus comprising:
at least one processor;
memory storing computer program code;
wherein the memory storing the computer program code is configured to, with the at least one processor, cause the apparatus to at least:
based on at least one of reception and content of a message indicating permission for a user device configured for device to device operation to use a discovery resource, allow or inhibit use of the discovery resource by the user device at a subsequent opportunity of use of the discovery resource.

44. The apparatus of claim 43, wherein the message indicates permission for use of all discovery resources available for use by the user device at a subsequent opportunity for use of the discovery resource.

45. The apparatus of claim 43, wherein the message points to a configured specific resource or configured resource group and indicates a grant or denial of use of discovery resource for the configured specific resource or the configured resource group allocated to the user device.

46. The apparatus of claim 43, wherein the message is part of a downlink control information.

47. The apparatus of claim 43, wherein the message is carried on a physical downlink control channel.

48. The apparatus of claim 46, wherein the downlink control information is a compact downlink control information format scrambled with a device to device radio network temporary identifier configured for user devices within coverage of a base station.

49. The apparatus of claim 43, wherein the apparatus is further caused to receive as part of the device to device operation configuration information identifying one or more specific resources or a resource group as well as the device to device radio network temporary identifier configured for the user device.

50. The apparatus of claim 43, wherein the message indicates explicit permission or denial of use of discovery resources for one or more specified user devices.

51. The apparatus of claim 50, wherein the message specifies at least one group of user devices and indicates explicit permission or denial of use of discovery resources for the at least one group, and wherein indicating explicit permission or denial of use of discovery resources comprises identifying the one or more specified user devices as member of the at least one group.

52. The apparatus of claim 50, wherein the message comprises a first element defining a group of indexes to user device groups and a second element comprising an index to user devices within the user device groups defined by the first element, such that the two elements together specify a user device.

53. The apparatus of claim 52, wherein the first element comprises a radio network temporary identifier.

54. The apparatus of claim 43, wherein failing to receive the message for a predetermined number of consecutive times indicates a deactivation of use of the discovery resource.

55. The apparatus of claim 43, wherein the reception of the message indicating permission to use the discovery resource comprises receiving a message indicating explicit denial of permission.

56. The apparatus of claim 55, wherein the receiving a message indicating explicit denial to use the discovery resource comprises an indication as to whether the denial applies only to a limited number of opportunities or indicates a deactivation of use of the discovery resource.

57. The apparatus of claim 55, wherein, if the receiving a message indicating explicit denial of permission to use the discovery resource exceeds a predetermined number of consecutive denials, the denial indicates the deactivation of use of the discovery resource.

58. An apparatus comprising:
at least one processor;
memory storing computer program code;
wherein the memory storing the computer program code is configured to, with the at least one processor, cause the apparatus to at least:
configure a message indicating grant or denial of permission to one or more user devices configured for device to device operation to use discovery resource at a subsequent opportunity for use of the discovery resource; and
transmit the message by a base station serving the one or more user devices configured for device to device operation.

59. The apparatus of claim 58, wherein the message indicates grant or denial of use of the discovery resource is configured by the base station.

60. The apparatus of claim 58, wherein the apparatus is further caused to:
transmit to the one or more user devices by the base station a message including information of allocating specific resources to the one or more user devices and defining a resource group to which the specific resources belong and providing an index assigning the specific resources to the one or more user devices; and
wherein the message points to a resource group, and indicates a grant or denial of a resource within the resource group and the resource or the resource group allocated to the one or more user devices.

61. The apparatus of claim 58, wherein the apparatus is further caused to transmit to the user devices by the base station a message indicating a grant or denial of one or more resource groups, wherein the grant or denial of the one or more resource groups indicates grant or denial of all resources comprising the one or more resource groups.

62. A method comprising:
based on at least one of reception and content of a message indicating permission for a user device configured for device to device operation to use a discovery resource, allowing or inhibiting use of the discovery resource by the user device at a subsequent opportunity of use of the discovery resource.
